(19) United States
(12) Patent Application Publication
(10) Pub. No.: US 2026/0259414 A1
(43) Pub. Date: Sep. 3, 2026

(54) OPTICAL MODULE AND HEAD-MOUNTED DISPLAY DEVICE

(71) Applicant: Goertek Optical Technology Co., Ltd., Shandong (CN)

(72) Inventor: Wenbao SONG, Shandong (CN)

(73) Assignee: Goertek Optical Technology Co., Ltd., Shandong (CN)

(21) Appl. No.: 18/879,885

(22) PCT Filed: Jun. 30, 2023
(86) PCT No.: PCT/CN2023/104454

§ 371 Date: Dec. 30, 2024

(30) Foreign Application Priority Data
Jun. 30, 2022 (CN) 202210769964.7

(51) Int. Cl. G02B 27/01; G02B 27/28

(52) U.S. Cl. CPC G02B 27/0172; G02B 27/28

(57) ABSTRACT

The disclosure provides an optical module and a head mounted display device. The optical module includes a first polarizing reflection element, a first phase retarder, a second polarizing reflection element, and at least one lens arranged between the first polarizing reflection element and the second polarizing reflection element. The first phase retarder is located between the first polarizing reflection element and the second polarizing reflection element. The first polarizing reflection element is configured to transmit one of horizontally and vertically polarized light and reflect the other of horizontally and vertically polarized light. The second polarizing reflection element is configured to transmit one of the left-hand and the right-hand circularly polarized light and reflect the other of the left-hand and right-hand circularly polarized light.

### CROSS-REFERENCE TO RELATED APPLICATIONS

The present disclosure is a National Stage of International Application No. PCT/CN2023/104454, filed on Jun. 30, 2023, which claims priority to Chinese Patent Application No. 202210769964.7, filed on Jun. 30, 2022, both of which are hereby incorporated by reference in their entireties.

### FIELD OF THE INVENTION

The present disclosure relates to the technical field of optical display technologies, and particularly, to an optical module and a head mounted display device.

### BACKGROUND OF THE INVENTION

In recent years, virtual reality (VR) devices have experienced rapid development. However, current VR devices generally suffer from the issue of large size, which to some extent detract from the user experience. Conventional folded optical path structures can effectively reduce the total length of the optical module, thereby reducing its volume and facilitating the miniaturization trend of VR optical modules. Nevertheless, in existing folded optical path solutions, light passes through a transflective component twice within the optical module, leading to relatively low light energy utilization.

### SUMMARY OF THE INVENTION

The object of the present disclosure to provide a new technical solution for an optical module and a head mounted display device that can effectively improve the utilization of the light energy in the optical module.

According to one aspect of the present disclosure, there is provided an optical module including a first polarizing reflection element, a first phase retarder and a second polarizing reflection element, wherein the first phase retarder is arranged between the first polarizing reflection element and the second polarizing reflection element;
the first polarizing reflection element is configured to transmit one of horizontally linearly polarized light and vertically linearly polarized light and reflect the other of horizontally linearly polarized light and vertically linearly polarized light. The second polarizing reflection element is configured to transmit one of left-hand circularly polarized light and right-hand circularly polarized light, and reflect the other of left-hand circularly polarized light and right-hand circularly polarized light;
the optical module further includes at least one lens, which is arranged between the first polarizing reflection element and the second polarizing reflection element.

Optionally, the at least one lens includes a first lens and a second lens;
the first lens and the second lens are arranged between the first polarizing reflection element and the first phase retarder.

Optionally, the optical module further includes a display screen, the first lens is arranged proximate to the display screen, and the second lens is arranged distal to the display screen.

Optionally, the optical module further includes a first polarizing element, which is arranged on one side of the first polarizing reflection element proximate to the display screen.

Optionally, a transmission axis of the first polarizing reflection element is parallel to a transmission axis of the first polarizing element;
an angle between the transmission axis of the first polarizing element and a fast axis or a slow axis of the first phase retarder is 45°.

Optionally, the first polarizing element is arranged on a light-emitting side of the display screen;
the first polarizing reflection element is arranged on a surface of the first lens proximate to the display screen;
the first phase retarder and the second polarizing reflection element are stacked and arranged on a surface of the second lens distal to the display screen.

Optionally, a lens is provided between the first polarizing element and a light-emitting surface of the display screen;
and/or, a lens is provided between the first polarizing element and the first polarizing reflection element.

Optionally, a lens is provided on one side of the second polarizing reflection element facing away from the first phase retarder.

Optionally, the at least one lens includes a first lens and a second lens;
the first lens is arranged between the first polarizing reflection element and the first phase retarder, and the second lens is arranged between the first phase retarder and the second polarizing reflection element.

Optionally, the at least one lens includes a first lens and a second lens;
the first lens and the second lens are arranged between the first phase retarder and the second polarizing reflection element.

Optionally, the optical module further includes a second phase retarder and a second polarizing element; the second phase retarder and the second polarizing element are arranged on one side of the second polarizing reflection element facing away from the first phase retarder, wherein the second phase retarder is arranged between the second polarizing element and the second polarizing reflection element.

Optionally, an angle between the transmission axis of the second polarizing element and a fast axis or a slow axis of the second phase retarder is 45°.

Optionally, the second polarizing element, the second phase retarder, the second polarizing reflection element and the first phase retarder are stacked sequentially to form a composite film, which is arranged on a surface of the second lens distal to the display screen.

According to another aspect of the present disclosure, there is provided a head mounted display device including:
a housing; and
the optical modules as described above.

The beneficial effects of the present disclosure are as follows:

Embodiments of the present disclosure provide a folded optical path scheme that introduces two different types of polarizing reflection elements into the optical path and eliminates the use of a transflective component. This approach effectively increases the light energy utilization in the optical module. When applied to a head mounted display (HMD) device, the optical module exhibits low power consumption, thereby extending the standby time of the HMD device. Additionally, the optical module ensures superior imaging quality.

Other features of the present disclosure and advantages thereof will become clear by the following detailed description of exemplary embodiments of the present disclosure with reference to the accompanying drawings.

### BRIEF DESCRIPTION OF THE DRAWINGS

The accompanying drawings incorporated in and constituting a part of the specification illustrate embodiments of present disclosure and together with the description thereof, serve to explain the principles of the disclosure.

FIG. 1 shows a structural schematic diagram of an optical module provided by an embodiment of the present disclosure;

FIG. 2 shows a structural schematic diagram of an optical module provided by another embodiment of the present disclosure;

FIG. 3 shows a structural schematic diagram of an optical module provided by a specific embodiment of the present disclosure;

FIG. 4 shows a modulation transfer function MTF curve at 450 nm for the optical module illustrated in FIG. 3;

FIG. 5 shows a modulation transfer function MTF curve at 540 nm for the optical module illustrated in FIG. 3;

FIG. 6 shows a modulation transfer function MTF curve at 610 nm for the optical module illustrated in FIG. 3.

### EXPLANATION OF REFERENCE NUMERALS

10, first lens; 20, second lens; 30, first polarizing reflection element; 40, first phase retarder; 50, second polarizing reflection element; 60, second phase retarder; 70, second polarizing element; 80, first polarizing element; 90, display screen; 100, optical axis; 01, human eye; 02, light.

### DETAILED DESCRIPTION OF THE EMBODIMENTS

Various exemplary embodiments of the present disclosure will now be described in detail with reference to the accompanying drawings. It should be noted that the relative arrangements of the components and steps, numerical expressions and values set forth in these embodiments do not limit the scope of the present disclosure unless otherwise specifically stated.

The following description of at least one exemplary embodiment is in fact merely illustrative and in no way serves as any limitation on the present disclosure and its application or use.

Techniques and devices known to those skilled in the art may not be discussed in detail, but where appropriate, the techniques and devices should be considered part of the specification.

In all examples shown and discussed herein, any specific value should be interpreted as merely exemplary rather than a limitation. Therefore, other examples of the exemplary embodiments may have different values.

It should be noted that similar reference numerals and letters represent similar items in the accompanying drawings below. Therefore, once an item is defined in one drawing, it is unnecessary to further discuss the item in the subsequent drawings.

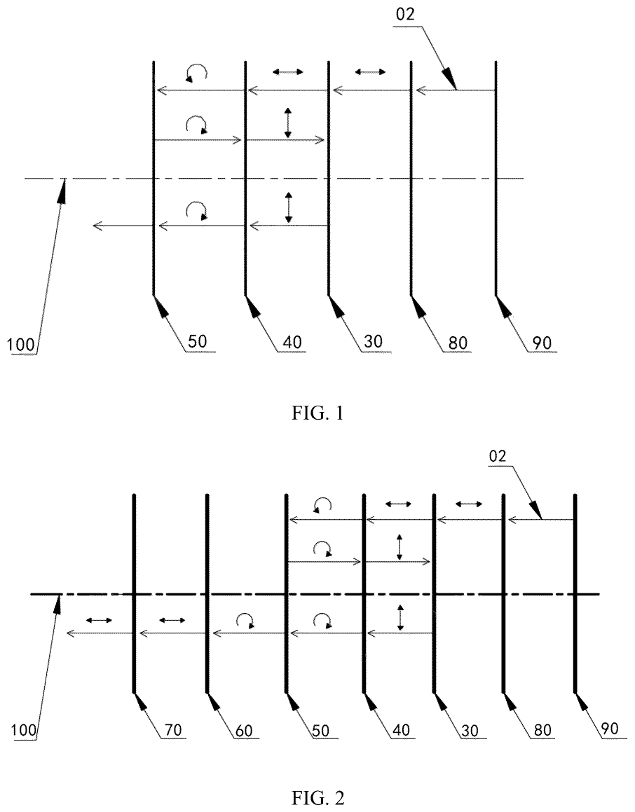

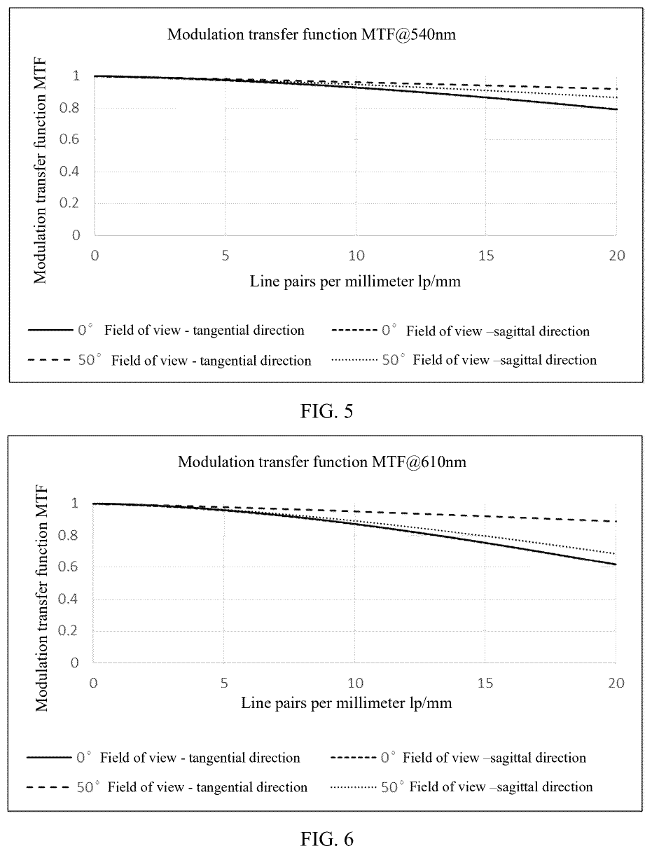

The optical module and the head mounted display device provided by embodiments of the present disclosure are described in detail below in conjunction with FIGS. 1 to 6.

According to an aspect of an embodiment of the present disclosure, there is provided an optical module. The optical module is a folded optical path structure, which is suitable for application in a head mounted display (HMD) device, such as VR smart glasses. The optical structure is designed to reduce the total length of the optical path and improve the light efficiency utilization of the optical module.

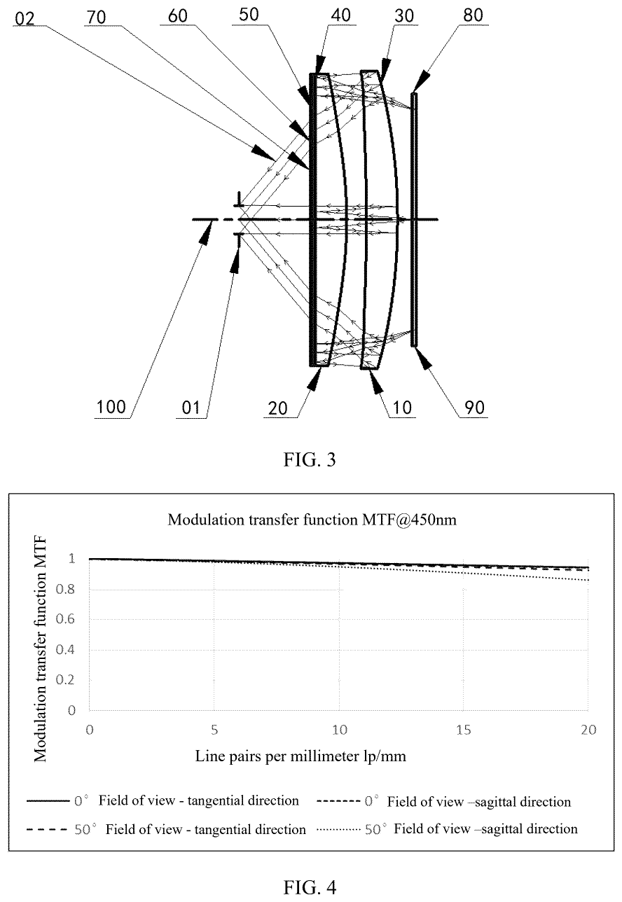

Embodiments of the present disclosure provide an optical module, as shown in FIGS. 1 and 3. The optical module includes a first polarizing reflection element 30, a first phase retarder 40 and a second polarizing reflection element 50 along a direction of an optical axis 100, wherein the first phase retarder 40 is arranged between the first polarizing reflection element 30 and the second polarizing reflection element 50.

Here, the first polarizing reflection element is configured to transmit one of horizontally linearly polarized light and vertically linearly polarized light, and to reflect the other of horizontally linearly polarized light and vertically linearly polarized light. The second polarizing reflection element 50 is configured to transmit one of left-hand circularly polarized light and right-hand circularly polarized light, and to reflect the other of left-hand circularly polarized light and right-hand circularly polarized light;

The optical module further includes at least one lens, which is located between the first polarizing reflection element 30 and the second polarizing reflection element 50.

In the optical module provided in the embodiments of the present disclosure, two different types of polarizing reflection elements are employed: the first polarizing reflection element 30 and the second polarizing reflection element 50, as described above. Additionally, this design eliminates the use of a transflective component within the optical path. This design addresses the conventional issue where light passes through the transflective component twice within the optical path due to the introduction of the transflective component, leading to reduced light energy utilization.

That is, by omitting the transflective component, the optical module provided in the embodiment of the present disclosure can effectively improve utilization of the light energy.

The optical module provided in the embodiment of the present disclosure may further include a lens group, in which at least one lens may be flexibly provided according to specific needs to meet the imaging demand of the optical module.

Optionally, the first polarizing reflection element 30, the first phase retarder 40 and the second polarizing reflection element 50 may each be provided as a separate component in the optical path structure, to form a folded optical path.

Of course, in the overall optical path design, it is also possible to attach the first polarizing reflection element 30 with the first phase retarder 40 together. Alternatively, it is also possible to attach the first phase retarder 40 together with the second polarizing reflection element 50, which is not limited in the embodiments of the present disclosure.

In the optical module provided by the embodiment of the present disclosure, the first polarizing reflection element 30, the first phase retarder 40 and the second polarizing reflection element 50 are located on the same optical axis 100, and the first phase retarder 40 should be located between the first polarizing reflection element 30 and the second polarizing reflection element 50, however, the specific position and manner of setting thereof can be flexibly adjusted according to the needs.

In the optical module provided by the embodiment of the present disclosure, the optical module can form a folded optical path structure by the first polarizing reflection element 30, the first phase retarder 40, and the second polarizing reflection element 50, as well as the lenses adapted to these optical elements, which is conducive to reducing the size of the optical module.

The optical module provided in the embodiment of the present disclosure is a folded optical path structure, as shown in FIGS. 1 and 3. Each optical lens and optical element in the optical module can be arranged in a predetermined manner and located on the same optical axis 100. The entire optical path structure has a small size and does not occupy a large space. It is very suitable for application in a smart wearable device, such as a VR head mounted display device.

Here, the first phase retarder 40 is, for example, a quarter-wave plate (film), or another types of phase retarder. The phase retarder can be used to change the polarization state of the light in the folded optical path structure. For example, it can convert linearly polarized light into circularly polarized light, or vice versa.

Here, the first polarizing reflection element 30 is a polarizing reflector which transmits horizontally linearly polarized light and reflects vertically linearly polarized light. Alternatively, it is a polarizing reflector which transmits vertically linearly polarized light and reflects horizontally linearly polarized light.

Of course, the first polarizing reflection element 30 may also be a polarizing reflection component for reflecting linearly polarized light at a particular angle and transmitting linearly polarized light in a direction perpendicular to the angle.

Here, the second polarizing reflection element 50 is a polarizing reflector that reflects left-hand circularly polarized light and transmits right-hand circularly polarized light. Alternatively, the second polarizing reflection element 50 is a polarizing reflector that reflects right-hand circularly polarized light and transmits left-hand circularly polarized light.

That is, the second polarizing reflection element 50 can reflect circularly polarized light of one polarization state and transmit circularly polarized light of another polarization state.

In the embodiment of the present disclosure, the transflective component can be eliminated by using two different polarizing reflection elements. Compared with the conventional folded optical path scheme using the transflective component, the light energy utilization in the optical module of the embodiment of the present disclosure can increase by up to three times, or even more. That is, the optical efficiency utilization of the optical module provided by the embodiment of the present disclosure is effectively increased.

The first polarizing reflection element 30 has a transmission axis along which light transmits, and an angle between the transmission axis of the first polarizing reflection element 30 and a fast axis or a slow axis of the first phase retarder 40 is 45°. That is, an angle between the transmission axis of the first polarizing reflection element 30 and the fast axis of the first phase retarder 40 is set to 45°, and an angle between the transmission axis of the first polarizing reflection element 30 and the slow axis of the first phase retarder 40 is set to −45°.

The first phase retarder 40 has the fast axis and the slow axis. Light in the same direction as the transmittance axis of the first polarizing reflection element 30 can transmit the first polarizing reflection element 30, and light orthogonal to the direction of the transmittance axis of the first polarizing reflection element 30 cannot transmit the first polarizing reflection element 30.

In the embodiment of the present disclosure, the first phase retarder 40 cooperating with the two polarizing reflection elements can be used to resolve the light, and transfer the light. The first phase retarder 40 should be arranged between the two polarizing reflection elements.

The embodiment of the present disclosure provide a folded optical path scheme, in which two different polarizing reflection elements are introduced into the optical path, and the transflective component is eliminated, so that the utilization of the light energy in the optical module can be improved. When the optical module is applied to the head mounted display device, the optical module has low power consumption, and the standby time of the head mounted display device can be increased. At the same time, the optical module can ensure good imaging quality.

In some examples of the present disclosure, the at least one lens includes a first lens 10 and a second lens 20. As shown in FIGS. 1 and 3, the first lens 10 and the second lens 20 are arranged between the first polarizing reflection element 30 and the first phase retarder 40.

That is, when the lens group of the optical module includes two lenses, i.e., the first lens 10 and the second lens 20 described above, the two lenses can be arranged between the first polarizing reflection element 30 and the first phase retarder 40. At this time, both of the first phase retarder 40 and the second polarizing reflection element 50 may be designed as a film structure and attached together. That is, the first polarizing reflection element 30 and the first phase retarder 40 can be separated by the two lenses described above.

It should be noted that when the first lens 10 and the second lens 20 are included in the lens group of the optical module, which is not limited to the setting manner in the above examples.

In some examples of the present disclosure, the first lens 10 and the second lens 20 can also be arranged between the first phase retarder 40 and the second polarizing reflection element 50. At this time, both of the first polarizing reflection element 30 and the first phase retarder 40 may be designed as film structures and attached together. That is, the second polarizing reflection element 50 and the first phase retarder 40 are separated by the two lenses.

In some examples of the present disclosure, the first lens 10 is arranged between the first polarizing reflection element 30 and the first phase retarder 40, and the second lens 20 is arranged between the first phase retarder 40 and the second polarizing reflection element 50.

That is, the two lenses may separate the first polarizing reflection element 30, the first phase retarder 40, and the second polarizing reflection element 50, so that the first polarizing reflection element 30, the first phase retarder 40, and the second polarizing reflection element 50 may be designed to be provided independently. By this design, a folded optical path structure can be formed in the optical path, causing light to be reflected therein to realize imaging.

When the first polarizing reflection element 30, the first phase retarder 40 and the second polarizing reflection element 50 are provided independently, it facilitates alignment and adjustment during their assembly, allowing for optical path calibration.

It should be noted that in order to reduce the difficulty of assembling the first polarizing reflection element 30, the first phase retarder 40 and the second polarizing reflection element 50, they can be attached to suitable surfaces of the first lens 10 and the second lens 20, while the first phase retarder 40 should be located between the first polarizing reflection element 30 and the second polarizing reflection element 50.

In some examples of the present disclosure, as shown in FIGS. 1 and 3, the optical module further includes a display screen 90. The first lens 10 is arranged proximate to the display screen 90, and the second lens 20 is arranged distal to the display screen 90.

The optical module provided in the embodiment of the present disclosure may also include a display screen 90 that forms a display side of the optical module. The display screen 90 has, for example, a light-emitting surface that can be used to emit imaging light.

When the optical module includes the first lens 10 and the second lens 20, the first lens 10 is arranged proximate to the display screen 90, and the second lens 20 is located on the same optical axis as the first lens 10 and is arranged distal to the display screen 90.

The light emitted from the light-emitting surface of the display screen 90 may be linearly polarized light, circularly polarized light or natural light, which is not limited in the embodiments of the present disclosure.

For example, the light-emitting surface of the display screen 90 may be attached with a screen protector.

In addition, the display screen 90 may be a self-illuminated screen or a reflective screen.

Here, the self-illuminated screen includes, but is not limited to LCD, LED, OLED, Micro-OLED, ULED and so on.

Here, the reflective screen includes, but is not limited to DMD (Digital Micromirror Device).

That is to say, in the optical module of the embodiment of the present disclosure, two polarizing reflection elements can be provided between the human eye 01 and the display screen 90, and the first phase retarder 40 is arranged between the two polarizing reflection elements. At the same time, lenses may be reasonably arranged between the respective optical elements described above in order to form a folded optical path. The specific number and positions of lenses are not specifically limited in the embodiments of the present disclosure.

In some examples of the present disclosure, as shown in FIGS. 1 and 3, the optical module further includes a first polarizing element 80, which is arranged on one side of the first polarizing reflection element 30 proximate to the display screen 90.

The optical module of the embodiment of the present disclosure further includes a first polarizing element 80, which is arranged between the first polarizing reflection element 30 and the light-emitting surface of the display screen 90. The incident light emitted by the light-emitting surface of the display screen 90 may be converted into for example, horizontally linearly polarized light, when passing through the first polarizing element 80.

Here, the first polarizing element 80 may, for example, be a linear polarizer.

The first polarizing element 80 has a transmission axis through which light passes, and the direction of the transmission axis may be along a horizontal direction, a vertical direction, or any other direction.

Optionally, an anti-reflective coating may be attached or coated to a surface on one side of the first polarizing element 80 distal to the display screen 90.

In some examples of the present disclosure, the transmittance axis of the first polarizing reflection element 30 is parallel to the transmittance axis of the first polarizing element 80. An angle between the transmittance axis of the first polarizing element 80 and the fast axis or the slow axis of the first phase retarder 40 is 45°.

In the embodiment of the present disclosure, the first polarizing reflection element 30 proximate to the display screen 90, is a polarizing reflector that transmits the horizontally linearly polarized light and reflects the vertically linearly polarized light. The transmitting axis of the first polarizing reflection element 30 is parallel to the transmitting axis of the first polarizing element 80 in front of the display screen 90.

Optionally, an anti-reflective coating may be attached or coated on a surface on one side of the first polarizing reflection element 30 proximate to the display screen 90.

In the embodiment of the present disclosure, the first phase retarder 40 proximate to the display screen 90 is, for example, a quarter-wave plate, and an angle between the fast axis or the slow axis direction thereof and the transmission axis direction of the first polarizing element 80 in front of the display screen 90 is +45° or −45°. The first phase retarder 40 enables the conversion of linearly polarized light into circularly polarized light and/or circularly polarized light into linearly polarized light in the optical path.

In a specific embodiment of the present disclosure, as shown in FIG. 3, the optical module includes a first lens 10 and a second lens 20, wherein the first lens 10 is proximate to the display screen 90 and the second lens 20 is located proximate to the human eye 01. A first polarizing reflection element 30 is arranged on a surface (rear surface) of the first lens 10 proximate to the display screen 90, and a first phase retarder 40 and a second polarizing reflection element 50 are stacked and attached to one a surface (front surface) of the second lens 20 proximate to the display screen 90. A first polarizing element 80 is attached to a light-emitting surface of the display screen 90.

In the embodiment of the present disclosure, the first polarizing reflection element 30 is attached to the surface of the first lens 10 proximate to the display screen 90, the first phase retarder 40 and the second polarizing reflection element 50 are attached together to the surface of the second lens 20 distal to the display screen 90, and the first polarizing element 80 is attached directly to the light-emitting surface of the display screen 90. This design reduces the difficulty and cost of assembling the optical elements.

Here, the first polarizing element 80, the first polarizing reflection element 30, the second polarizing reflection element 50, and the first phase retarder 40 may be attached to planar surfaces, spherical surfaces, aspherical surfaces, cylindrical surfaces, free-form curved surfaces, and other forms of curved surfaces, which are not limited in the embodiments of the present disclosure.

Of course, the first polarizing element 80, the first polarizing reflection element 30, the second polarizing reflection element 50, and the first phase retarder 40 may also be independent optical components in the optical path, and which can be selected flexibly by the person skilled in the art according to the specific needs, and are not specifically limited in the present disclosure.

According to the optical module of the above specific embodiment, as shown in FIG. 3, the light propagation process is as follows:
the light 02 emitted from the display screen 90 becomes horizontally linearly polarized light after transmitting the first polarizing element 80, horizontally linearly polarized light after transmitting the first polarizing reflection element 30, and left-hand or right-hand circularly polarized light after transmitting the first phase retarder 40; then becomes right-hand or left-hand circularly polarized light after being reflected by the second polarizing reflection element 50, vertically linearly polarized light after transmitting the first phase retarder 40, and then forms vertical linearly polarized light after being reflected by the first polarizing reflection element 30, and becomes right-hand or left-hand circularly polarized light after transmitting the first phase retarder 40 again, and then enters the human eye 01 for imaging after transmitting the second polarizing reflection element 50.

In addition, it is noted that in the optical module of the embodiment of the present disclosure, the display screen 90, the first polarizing element 80, the first polarizing reflection element 30, and the first phase retarder 40 may be arranged separately, or may be attached together.

In an example of the present disclosure, as shown in FIG. 1, a lens is provided between the first polarizing element 80 and the light-emitting surface of the display screen 90; and/or, a lens is provided between the first polarizing element 80 and the first polarizing reflection element 30.

In an example embodiment of the present disclosure, as shown in FIG. 1, a lens is provided on one side of the second polarizing reflection element 50 facing away from the first phase retarder 40.

In the optical module provided by the embodiment of the present disclosure, two kinds of polarizing reflection elements, and a polarizing element and a phase retarder are used in the optical path structure to realize the optical path folding, and a transflective component in the optical path structure is eliminated. In the whole optical path, the number and positions of lenses can be adjusted as needed.

For example, as shown in FIG. 1, lenses can be provided between the display screen 90 and the first polarizing element 80, between the first polarizing element 80 and the first polarizing reflection element 30, between the first polarizing reflection element 30 and the first phase retarder 40, between the first phase retarder 40 and the second polarizing reflection element 50, and in front of the second polarizing reflection element 50 (i.e., between the second polarizing reflection element 50 and the human eye 01) as needed to change the direction of light propagation to realize imaging.

In some examples of the present disclosure, as shown in FIG. 2, the optical module further includes a second phase retarder 60 and a second polarizing element 70. The second phase retarder 60 and the second polarizing element 70 are arranged on one side of the second polarizing reflection element 50 facing away from the first phase retarder 40, wherein the second phase retarder 60 is arranged between the second polarizing element 70 and the second polarizing reflection element 50.

In the embodiment of the present disclosure, one second phase retarder 60 and one second polarizing element 70 can also be provided on the side of the second polarizing reflection element 50 distal to the display screen 90 (it can also be referred to as “proximate to the human eye 01”) to form an optical structure in such way that it can effectively block the left-hand or right-hand circularly polarized light that transmitting the second polarizing reflection element 50 on the first incidence due to the error of the second polarizing reflection element 50 itself, which in turn can effectively reduce stray light and better improve the imaging quality.

Here, the second polarizing element 70 distal to the display screen 90, is a polarizing reflector that reflects left-hand or right-hand circularly polarized light and transmits right-hand or left-hand circularly polarized light. The second polarizing element 70 is different from the first polarizing reflection element 30 proximate to the display screen 90.

Optionally, the second polarizing element 70 may be made of an electromagnetic metamaterials, or it may be made of other materials capable of reflecting left-hand or right-hand circularly polarized light and transmitting right-hand or left-hand circularly polarized light.

In some examples of the present disclosure, the angle between the transmission axis of the second polarizing element 70 and the fast axis or slow axis of the second phase retarder 60 is 45°.

The second phase retarder 60 may be arranged between the first polarizing reflection element 30 and the second polarized element 70. The second phase retarder 60 has a fast axis and a slow axis, and the fast axis or the slow axis direction of the second phase retarder 60 can be at any angle relative to the transmittance axis direction of the first polarizing element 80 proximate to the display screen 90. The angle between the transmission axis direction of the second polarizing element 70 and the fast axis or slow axis direction of the second phase retarder 60 is +45° or −45°.

In a specific embodiment of the present disclosure, as shown in FIG. 3, the optical module includes a first lens 10 and a second lens 20, wherein the first lens 10 is proximate to the display screen 90 and the second lens 20 is proximate to the human eye 01. A first polarizing reflection element 30 is arranged on the surface (rear surface) of the first lens 10 proximate to the display screen 90. The second polarizing element 70, the second phase retarder 60, the second polarizing reflection element 50 and the first phase retarder 40 are stacked and provided to form a composite film, which is provided on the surface (front surface) of the second lens 20 distal to the display screen 90. A first polarizing element 80 is attached to the light-emitting surface of the display screen 90.

In the embodiment of the present disclosure, the second polarizing element 70, the second phase retarder 60, the second polarizing reflection element 50 and the first phase retarder 40 can be designed as a film structure, which can be attached to each other to form a composite film by optical adhesive, and then the composite film can be attached to the front surface of the second lens 20 by optical adhesive. This manner can reduce the difficulty of assembling the second polarizing element 70, the second phase retarder 60, the second polarizing reflection element 50 and the first phase retarder 40, and can facilitate reducing the total length of the optical module.

In addition, the second polarizing element 70, the second phase retarder 60, the second polarizing reflection element 50, and the first phase retarder 40 may also be provided in the optical path structure as separate components.

According to the optical module provided in the above specific embodiment, the light propagation process is as follows:

As shown in FIG. 3, the light 02 emitted from the display screen 90 becomes horizontally linearly polarized light after transmitting the first polarizing element 80, horizontally linearly polarized light after transmitting the first polarizing reflection element 30, and left-hand or right-hand circularly polarized light after transmitting the first phase retarder 40; then becomes right-hand or left-hand circularly polarized light after being reflected by the second polarizing reflection element 50, vertically linearly polarized light after transmitting the first phase retarder 40, and then forms vertical linearly polarized light after being reflected by the first polarizing reflection element 30, and becomes right-hand or left-hand circularly polarized light after transmitting the first phase retarder 40 again, then right-hand or left-hand circularly polarized light after transmitting the second polarizing reflection element 50, and then horizontally linearly polarized light after transmitting the second phase retarder 60, and then enters the human eye 01 for imaging after transmitting the second polarizing element 70.

In some examples of the present disclosure, at least one of the first phase retarder 40 and the second phase retarder 60 is a quarter-wave plate.

The embodiments of the present disclosure provide an optical module that can improve the optical efficiency utilization. The optical efficiency utilization can increase by three times or even higher than that of the conventional folded optical module. Better imaging quality can also be ensured.

### Embodiment 1

As shown in FIG. 1, the optical module includes a first lens 10 and a second lens 20 sequentially along the optical axis 100 direction. The first lens 10 is arranged proximate to the display screen 90, and the second lens 20 is arranged distal to the display screen 90 or arranged proximate to the human eye 01.

A first polarizing reflection element 30 is arranged on the surface (rear surface) of the first lens 10 proximate to the display screen 90. A second polarizing element 70, a second phase retarder 60, a second polarizing reflection element 50 and a first phase retarder 40 are stacked to form a composite film, which is arranged on the surface (front surface) of the second lens 20 distal to the display screen 90. A first polarizing element 80 is attached to the light-emitting surface of the display screen 90, and the light-emitting surface of the display screen 90 is used to emit the incident light.

Here, the first polarizing reflection element 30 is configured to transmit horizontally linearly polarized light and reflect vertically linearly polarized light. The second polarizing reflection element 50 is configured to transmit one of left-hand circularly polarized light and right-hand circularly polarized light, and reflect the other of left-hand circularly polarized light and right-hand circularly polarized light.

Here, the first phase retarder 40 and the second phase retarder 60 are both quarter-wave plates.

The transmittance axis of the first polarizing reflection element 30 is parallel to the transmittance axis of the first polarizing element 80; and the angle between the transmittance axis of the second polarizing element 70 and the fast axis or slow axis of the second phase retarder 60 is 45°.

Specific parameters of the optical module provided in Embodiment 1 are shown in Table 1.

TABLE 1
List of structural parameters

| | | | thickness/ | radius of | 4th-order | 6th-order | 8th-order |
|---|---|---|---|---|---|---|---|
| | | | gap | curvature | aspheric | aspheric | aspheric |
| Elements | Material | Surface | mm | mm | coefficients | coefficients | coefficients |
| Human eye | / | / | 13.0 | Inf | / | / | / |
| 01 | | | | | | | |
| Second | / | Front | 0.08 | Inf | / | / | / |
| polarizing | | surface | | | | | |
| element 70 | | Rear | 0 | Inf | / | / | / |
| | | surface | | | | | |
| Second | / | Front | 0.08 | Inf | / | / | / |
| phase | | surface | | | | | |
| retarder 60 | | Rear | 0 | Inf | / | / | / |
| | | surface | | | | | |
| Second | / | Front | 0.08 | Inf | / | / | / |
| polarizing | | surface | | | | | |
| reflection | | Rear | 0 | Inf | / | / | / |
| element 50 | | surface | | | | | |
| First phase | / | Front | 0.08 | Inf | / | / | / |
| retarder 40 | | surface | | | | | |
| | | Rear | 0 | Inf | / | / | / |
| | | surface | | | | | |
| Second | PMMA | Front | 5.5 | Inf | / | / | / |
| lens 20 | | surface | | | | | |
| | | Rear | 3.4 | −77.3 | −4.65E−08 | 2.09E−08 | −4.72E−11 |
| | | surface | | | | | |
| First | PMMA | Front | 5.5 | −2200.0 | −1.73E−05 | 9.42E−08 | −2.33E−10 |
| lens 10 | | surface | | | | | |
| | | Rear | 0 | −110.0 | −4.29E−06 | 1.89E−08 | −3.76E−11 |
| | | surface | | | | | |
| First | / | Front | 0.08 | −110.0 | −4.29E−06 | 1.89E−08 | −3.76E−11 |
| polarizing | | surface | | | | | |
| reflection | | Rear | 2.5 | −110.0 | −4.29E−06 | 1.89E−08 | −3.76E−11 |
| element 30 | | surface | | | | | |
| First | / | Front | 0.08 | Inf | / | / | / |
| polarizing | | surface | | | | | |
| element 80 | | Rear | 0 | Inf | / | / | / |
| | | surface | | | | | |
| Display | BK7 | Front | 0.5 | Inf | / | / | / |
| screen 90 | | surface | | | | | |
| | | Rear | 0 | Inf | / | / | / |
| | | surface | | | | | |

FIGS. 4 to 6 show the modulation transfer function MTF curves at 450 nm, 540 nm, and 610 nm for the optical module provided by the embodiment of the present disclosure, respectively.

As can be seen in FIGS. 4 to 6 at 20 lp/mm spatial frequency:

The MTF value at the wavelength of 450 nm for the optical module is higher than 0.84.

The MTF value at the wavelength of 540 nm for the optical module is higher than 0.78.

The MTF at the wavelength of 610 nm for the optical module is higher than 0.6.

The optical module provided by the embodiment of the present disclosure can realize clear imaging.

According to another aspect of the embodiment of the present disclosure, there is also provided a head mounted display device, which includes a housing, and the optical module as described above.

The head mounted display device is, for example, a VR head mounted device, including VR glasses or a VR helmet, etc., which are not specifically limited in in the embodiments of the present disclosure.

The specific implementation of the head mounted display device of the embodiments of the present disclosure can be referred to the respective embodiment of the above optical module, and thus has at least all the beneficial effects brought about by the technical solutions of the above embodiments, which will not be repeated herein.

The above embodiments focus on describing the differences between the various embodiments, and the optimization features between the various embodiments, as long as they do not contradict each other, can be combined to form a more optimal embodiment, which will not be repeated herein considering the brevity of the text.

Although some particular embodiments of the present disclosure have been described in detail by way of example, those skilled in the art should understand that the above examples are for illustrative purposes only and are not intended to limit the scope of the present disclosure. Those skilled in the art should understand that the above embodiments may be modified without departing from the scope and spirit of the present disclosure. The scope of the disclosure is limited by the appended claims.

1. An optical module, comprising:
a first polarizing reflection element,
a first phase retarder,
a second polarizing reflection element, and
at least one lens, arranged between the first polarizing reflection element and the second polarizing reflection element,
wherein the first phase retarder is arranged between the first polarizing reflection element and the second polarizing reflection element;
the first polarizing reflection element is configured to transmit a first of horizontally linearly polarized light and vertically linearly polarized light, and to reflect a second of the horizontally linearly polarized light and the vertically linearly polarized light; and the second polarizing reflection element is configured to transmit a first of left-hand circularly polarized light and right-hand circularly polarized light, and to reflect a second of the left-hand circularly polarized light and the right-hand circularly polarized light.

2. The optical module according to claim 1, wherein the at least one lens comprises a first lens and a second lens;
the first lens and the second lens are arranged between the first polarizing reflection element and the first phase retarder.

3. The optical module according to claim 2, further comprises a display screen, wherein the first lens is arranged proximate to the display screen, and the second lens is arranged distal to the display screen.

4. The optical module according to claim 3, further comprises a first polarizing element, which is arranged on one side of the first polarizing reflection element proximate to the display screen.

5. The optical module according to claim 4, wherein a transmission axis of the first polarizing reflection element is parallel to a transmission axis of the first polarizing element; and
an angle between the transmission axis of the first polarizing element and a fast axis or a slow axis of the first phase retarder is 45°.

6. The optical module according to claim 4, wherein the first polarizing element is arranged on a light-emitting surface of the display screen;
the first polarizing reflection element is arranged on a surface of the first lens proximate to the display screen; and
the first phase retarder and the second polarizing reflection element are stacked and arranged on a surface of the second lens distal to the display screen.

7. The optical module according to claim 4, wherein a lens is provided between the first polarizing element and a light-emitting surface of the display screen; and/or,
a lens is provided between the first polarizing element and the first polarizing reflection element.

8. The optical module according to claim 1, wherein a lens is provided on one side of the second polarizing reflection element facing away from the first phase retarder.

9. The optical module according to claim 1, wherein the at least one lens comprises a first lens and a second lens;
the first lens is arranged between the first polarizing reflection element and the first phase retarder, and the second lens is arranged between the first phase retarder and the second polarizing reflection element.

10. The optical module according to claim 1, wherein the at least one lens comprises a first lens and a second lens;
the first lens and the second lens are arranged between the first phase retarder and the second polarizing reflection element.

11. The optical module according to claim 10, further comprises a second phase retarder and a second polarizing element;
wherein the second phase retarder and the second polarizing element are arranged on one side of the second polarizing reflection element facing away from the first phase retarder, and wherein the second phase retarder is arranged between the second polarizing element and the second polarizing reflection element.

12. The optical module according to claim 11, wherein an angle between the transmission axis of the second polarizing element and a fast axis or a slow axis of the second phase retarder is 45°.

13. The optical module according to claim 11, wherein the second polarizing element, the second phase retarder, the second polarizing reflection element, and the first phase retarder are stacked sequentially to form a composite film, which is arranged on a surface of the second lens distal to the display screen.

14. A head mounted display device characterized by comprising:
a housing; and
an optical module according to claim 1.
